(19) United States
(12) Patent Application Publication
(10) Pub. No.: US 2022/0392659 A1
(43) Pub. Date: Dec. 8, 2022

(54) PROCESS FOR THE DECONTAMINATION OF RADIOACTIVELY CONTAMINATED MATERIALS

(71) Applicant: High Energy Technologies IP Holding GK, Oita (JP)

(72) Inventors: Jun NISHIMAGI, Fukushima (JP); Toru FURUTANI, Shimane (JP); Hiroyuki HASHIMOTO, Oita (JP); Tetsuya FURUTANI, Shimane (JP)

(73) Assignee: High Energy Technologies IP Holding GK, Oita (JP)

(21) Appl. No.: 17/765,104

(22) PCT Filed: Sep. 29, 2020
(86) PCT No.: PCT/JP2020/040333

§ 371 Date: Mar. 30, 2022

(30) Foreign Application Priority Data
Sep. 30, 2019 (EP) 19200636.9
Jul. 10, 2020 (EP) 20185367.8

(51) Int. Cl. G21F 9/06; G21F 9/30

(52) U.S. Cl. CPC G21F 9/06; G21F 9/30

(57) ABSTRACT

The present invention relates to a process for the decontamination of radioactively contaminated material comprising the steps of a) providing radioactively contaminated material in a decontamination bath (200), b) providing a reactor unit (107) comprising a first reactor chamber (102) connected to a second reactor chamber (103), c) electrolyzing water with a ph>7 in the first reactor chamber (102) and generating (H₃O₂)ₙ, d) generating nanobubbles in the electrolyzed water of the second reactor chamber (103), e) optionally repeating steps c) and d), f) applying pressure to the water which contains nanobubbles, g) transferring the pressurized water which contains nanobubbles to a decontamination bath (200) containing an α-ray generator and the radioactively contaminated materiel, h) charging the nanobubbles with the α-particles emitted by the α-ray generator, and i) bringing the charged nanobubbles in contact with the radioactively contaminated material in the decontamination bath (200).

### FIELD OF THE INVENTION

The present invention relates to the weakening of the radioactivity of radioactive materials by immersing radioactive contaminants in a cleaning solution.

### STATE OF THE ART

After the radioactive leakage due to the nuclear accident at Fukushima Daiichi Nuclear Power Plant following the Great East Japan Great Earthquake of March 2011, various industrial fields were seriously damaged.

One of the most imminent problems is the handling of a large amount of radioactive contaminants generated during decontamination operations. Because of the high radiation dose, it is not general waste and, thus left in the temporary storage place, and consequently even temporary storage cannot be secured at last. One of the most pressing objectives and challenges was therefore to develop a method that can effectively reduce radioactivity without creating highly contaminated disposals. Radioactive materials derived from the nuclear accident include iod-131, caesium-134, caesium-137, strontium-90, Plutonium-239, etc.

One of the radioactive materials generated in large amounts is wood from the forests surrounding Fukushima.

Immediately after the accident, specifically the bark of trees have been contaminated by huge amounts of radionuclides.

Many methods for reducing radioactive contamination have been proposed, most of which rely on the use of materials such as zeolites or plants to adsorb radionuclides, and just shielding in a certain container. In such processes, the absorbents become radioactive and should require subsequent disposal, usually by long-term burial. It is therefore highly desirable to find a way for radioactive decontamination by converting radioactive nuclides into stable elements without any radioactive activity.

Sugihara (Water 5, 69-85. 2013 and Int. J. Curr. Res. Aca.Rec. 2015; 3 (8): 196-207) suggested the use of infoton containing activated water put under high pressure in specifically designed activated pots to decontaminate radioactively contaminated soil from Fukushima and claimed to have reduced the radioactivity of the soil by up to 60%. The radioactivity could be reduced by treatment with activated water or with an energized substance exposed to activated water. The experiments were conducted with contaminated soil samples which were placed in a specially treated pot together with water. The pot was fabricated from pellets of acrylic-styrene which were energized by immersion in pressurized water and repeated detonation. Injection moulding of the pellets yielded the pot.

The authors explained this phenomenon of reduced radioactivity as the effect of an extended particle on a nucleus as for example Caesium-137. Bleecker D, Wilson L (1978: Stability of Gauss maps. Illinois J Math 22: 270-289) and Shima H, Ono S, Taira H. (2009: Quantum mechanics on a curved surface and its application to materials science. J Surf Sci Soc Jpn 30: 652-658) suggest that the potential around the nucleus and particle is of spherical shape with Gaussian curvature enabling a reaction within an extremely short time and very small space in the picosecond and picometer range respectively. Upon breakage of a hydrogen bond of a water molecule, the proton and electron remain inside the water molecule instead of forming hydronium ions or hydroxyl ions. The energy associated with spin and momentum is retained and a weak terahertz radiation is emitted. This fragment carrying energy in a water molecule is called an infoton. The infoton is an elementary particle with a stable existence and consists of a proton and an electron being in a plasma state. This hypothetic particle is assumed to function as a long-wavelength electromagnetic wave. Its energy transfers to another substance in form of an electromagnetic wave. The authors explain the long wavelength synthesis of elements by reaction of caesium-137 with high energetic infotons whose energy corresponds for example to 1170 keV at 5% of light velocity, which is close to the photon energy from caesium-137. With decreasing distance between caesium-137 and the infoton, the potential curvature increases under reduction of the energy of the caesium-137 nucleus through emission of photons. Concurrently, the infoton regains energy from caesium-137 causing it to climb the potential slope which facilitates the interaction with the nucleus and leads to the formation of stable elements.

Analytical investigations of infoton treated aqueous soil extracts showed that the radioactive materials were converted into barium, lanthanum, and cerium. The detected levels of these elements were markedly different from those usually found in soil.

Sugihara (Sugihara et al. EC Agriculture 5.3 (2019): 134-138) described recently the change of instable radioactive elements to stable ones.

Thorium nuclei are susceptible to α-decay because the strong nuclear force cannot overcome the electromagnetic repulsion between their protons. The α-decay of thorium-232 initiates the 4n decay chain which includes isotopes with a mass number divisible by 4. This chain of consecutive α- and β⁻-decays begins with the decay of the naturally occurring thorium-232 to radon-228 and terminates at lead-208. The thorium cascade includes the following elements: actinium, bismuth, lead, polonium, radium, radon, thallium. All elements are present at least transiently in any natural thorium containing sample, whether metal, compound or mineral. The total energy release from thorium-232 to lead-208 including the energy lost to neutrinos is 42.6 MeV. The thorium-232 decay chain includes α- as well as β⁻-decays. The α-decay is defined by the emission of an α-particle which has an atomic mass of 4 u and consists of 4 neutrons and 4 protons which is consistent with the nucleus of a helium atom and can also be expressed in the form ⁴He²⁺, a two times positively charged helium atom. By emission of an α-particle, the atomic mass of the decaying element is decreased by 4, namely 2 protons and 2 neutrons (2p2n). This yields a new isotope of an element having an order number reduced by 2 in the periodic system of the elements. On the other hand, the β⁻-decay is defined by the emission of a β-particle, which is a high energetic electron from the nucleus. In case of the β⁻-decay, a neutron of the nucleus is transformed into a proton under release of an electron accompanied by an antineutrino. By the β⁻-decay, the number of protons in the decaying nucleus is increased by one, yielding therefore an isotope of a new element with an order number increased by one in the periodic system of the elements having approximately the same mass of the nucleus before the decay. The first step in the thorium-232 cascade is the decay of 232Th90 (thorium nucleus with 90 protons and 142 neutrons: 90p142n) to 228Ra88 (radon nucleus with 88 protons and 140 neutrons: 88p140n) under emission of 2p2n. This step is followed by two β⁻-decays to actinium (228Ac89) and thorium (228Th90). By consecutive a-decays isotopes of radium (224Ra88), radon (220Rn86), polonium (216Po84) and finally lead (212Pb82) are formed whereby several β⁻-decays are also occurring. By these numerous α-decays, helium nuclei are formed.

Tritium occurs in different forms in radioactive effluents. It is produced by fission reactions in a nuclear reactor and may be in the form of a gas, as tritiated water molecules or its ions [³₁H]⁺ and [O³₁H]⁻. However, no economically feasible technology exists to filter tritium from a nuclear power plant's gaseous and liquid emissions to the environment. The treatment of effluents is especially complex in the nuclear industry. A specific case is the treatment of the tritium problem in the Fukushima accident.

The company treating the liquid effluent from Fukushima uses a filtering system to clean the thousands of tons of radioactive water the plant generates each day, as a result of the accident caused by the earthquake and tsunami of March 2011. However, tritium is the only one of the radioactive isotopes that the filtering system is unable to remove. The Japanese Ministry of Economy, Commerce and Industry considers in agreement with the International Atomic Energy Agency that in such a context the controlled discharging of tritium into the sea is an acceptable practice. The estimated costs for this are 3.4 billion yen (€ 27.5 million) and the process takes almost seven and a half year.

Tritium is a radioactive isotope of hydrogen with a mass of 3.01605 g/mol and a half-life of 12.33 years. Its beta decay occurs according to ³₁H→³₂H¹⁺+e⁻+v̅ₑ into a positively charged helium-3 isotope, and electron (which is the β⁻-particle) and an electron antineutrino under release of 18.6 keV. As the neutron changes into a proton, the hydrogen changes into helium. The mean electron's kinetic energy is 5.7 keV while the remaining energy is carried off by the nearly undetectable electron antineutrino. β⁻-particles from tritium can penetrate only about 6 mm of air. 1 g Tritium has an activity of 3.56·10¹⁴ Becquerel or decays per second respectively.

Tritium has the same chemical behaviour as deuterium and protium, as the chemical properties depend on the outer electrons. This feature makes it difficult to separate it chemically from other isotopes.

The emitted low energy β⁻-particle cannot penetrate the skin. But tritium does pose health risks if it is ingested, inhaled or if it enters the body through an open wound. It emits within the body irradiating the cellular, bones and lymphatic system and, in general the entire internal organism. Therefore, the introduction of tritium in the organism due to contamination is a serious health problem.

Tritium is formed in nuclear fuels primarily by ternary fission. It is also formed by neutron activation of a series of light elements present as impurities or as components of the fuel, coolant, moderator, sheaths and other nuclear materials. So it is produced in fission reactors that use heavy water (deuterium oxide) as a moderator, whereby deuterium captures a neutron under formation of tritium. In pressurized water reactors, lithium hydroxide is used to regulate the acidity. Thereby, tritium is formed by interaction of lithium-6 with neutrons. Also boric acid, which regulates the fission rate in the reactor leads to the formation of tritium.

The boron-10 isotope absorbs a neutron forming boron-11 which turns into the unstable lithium-7 which in turn decomposes into tritium and helium. Tritium occurs also as a fission product in ternary fissions of uranium-235 and plutonium-239.

The tritium generated in nuclear reactions occurs partly in the form of tritium gas ³₁H₂ but mainly as a part of the water molecule in the form ³₁H—O—H(T—OH); (³₁H)₂O (T₂O).

Current efforts focus on the separation of tritiated species. The chemical and physical properties of tritium, as well as the different combination options in the formation of water molecules currently complicate a large-scale industrial separation. There are several industrially scalable technologies to address the problem of filtering tritium. For example tritium can be captured using transition metals or a cobalt zirconium alloy under formation of hydrides (T. Motyka, Hybrides for processing and Storing Tritium, Hydrogen Technology Section of the Savannah River Technology. WSRC. 2000. pp. 187-195) in combination with cryogenic distillation preceded by electrolysis that converts the tritiated water into T₂ and other hydrogen isotopes (R. Sherman, Cryogenic Hydrogen Distillation for The Fusion Fuel Cycle, Fusion Technology Vol. 8 September 1985 pp. 2175-2183).

Nanobubbles have attracted much attention over the last years (see for example (Jay N. Meegoda, Shaini Aluthgun Hewage, and Janitha H. Batagoda, Stability of Nanobubbles, Env. Eng. Sci. Vol. 35, 11, 2018)).

Nanobubbles or ultrafine bubbles are defined as cavities of gases with a diameter <200 nm in aqueous solutions. The industrial application of nanobubbles was exponentially increased over the past two decades due to their reactivity and stability, compared with macro- and microbubbles.

Due to their size, they have high specific surface areas and high stagnation times which increases mass transport efficiencies, physical absorptions, and chemical reactions at the gas-liquid interfaces. Moreover, these bubbles have long residence time in solutions and electrically charged surfaces. Due to the above, nanobubbles have many industrial applications such as manufacturing of functional materials, soil and sediment decontamination, pharmaceutical delivery, drinking water and wastewater treatment as well as disinfection of food products (Li et al. Int. J. Environ. Res. Public Health 2014, 11, 473-486).

After generation, nanobubbles are found to exist in aqueous solutions for several weeks. It was reported that bubbles with radii of 150-200 nm were detectable for 2 weeks. Without being bound by theory, it is assumed that the electrically charged liquid-gas interface of nanobubbles create repulsive forces that prevent bubble coalescence, and hence, high bubble densities creating highly dissolved gas concentrations in water creating smaller concentration gradients between the interface and the bulk liquid. Moreover, the stability of bubbles increased by low rising velocity which is negligible due to Brownian motion and low buoyancy forces. Other than these reasons, nanobubbles are considered to be stable by a mutual shielding against the diffusive outflow of gases, which can be achieved if bubbles are sufficiently close together or gathered into micrometer-sized clusters. It also appears that they can change the physico-chemical properties of water (Ushikubo et al. Colloids and Surfaces A Physicochem. Eng. Aspects (2010)).

As of now, presence of stable nanobubbles has been experimentally confirmed, yet a clear theoretical basis has not been established to explain their long-term stability. Hence, for effective and functional use of these bubbles, knowing their properties and behaviour is quite important. Yet, nanobubble behaviour is considered to be complex. Li et al described the use of water nanobubbles for groundwater remediation (Li et al. Int. J. Environ. Res. Public Health 2014, 11, 473-486).

For an effective and functional use of nanobubbles, it is important to know the reason for their long-term stability. Therefore, a comprehensive laboratory investigation was performed to determine bubble size distributions and zeta potentials of nanobubbles, first with four different gases (test series I), then with different salt concentrations, pH levels, and temperatures of the solution (test series II).

Experimental results from test series I showed that the average bubble size depended on the gas solubility in water, and the zeta potential depended on the ability of the gas to generate OH⁻ ions at the water-gas interface.

Experimental results from test series II showed that bubbles with high negative zeta potentials can be generated in solutions of high pH, low temperatures, and low salt concentrations. The high pH solutions produced smaller but stable nanobubbles (Jay N. Meegoda, Shaini Aluthgun Hewage, and Janitha H. Batagoda, Stability of Nanobubbles, Env. Eng. Sci. Vol. 35, 11, 2018; DOI: 10.1089/ees.2018.0203).

The electrokinetic zeta potential arise from the negative surface charge on the bubble surface. It is assumed that the measured negative zeta potential of the nanobubbles with infilled gas results from the absorption of OH⁻ ions at the gas-water interface (Takahashi, M. (2005), Zeta potential of microbubbles in aqueous solutions: Electrical properties of the gas-water interface. J. Phys. Chem. B. 109, 21858; Temesgen, T., Bui, T. T., Han, M., Kim, T. I., and Park, H. (2017), Micro and nanobubble technologies as a new horizon for water-treatment techniques: A review. Adv. Colloid Interface Sci. 246, 40). Gases enclosed in the bubbles which are able to contribute to the formation of OH⁻ ions at the bubble-water interface showed highest zeta potential values. Ozone which is a very soluble as well as a very reactive gas when it dissolves in water is able to react with water under formation of hydroxide ions (Eagleton, J. (1999). Ozone in drinking water treatment).

Upon generating nanobubbles in the tritium effluents, where besides gaseous tritium mainly the two forms of tritiated water molecules are present, the nanobubbles also are built up partly by the tritium compounds. In particular, the tritiated water compounds does not differ in any way chemically or in their electrical features. Thus, they are able to form nanobubbles with water molecules.

The gaseous components are due to the applied high pressure to the liquid prone to get enclosed in the nanobubbles thereby contributing to their stabilization.

Since tritium is decaying under beta radiation, also the tritiated water molecules which are part of the nanobubbles decompose. According to the beta decay, a mono tritiated water molecule, which consists of one oxygen atom, one protium atom and one tritium atom, decays to a helium-3 isotope, an electron antineutrino, an electron and an OH radical.

The emitted low energetic electron has a maximum range of a few microns in water and is able to contribute to the formation of hydroxyl ions (OH⁻) which in turn stabilize the nanobubble sizes due to an increase of the bubble's zeta potential. The stable nanobubbles are of smaller size, have a negligible tendency to grow and their high zeta potential reduces the possibility of bubble coalescence. On the other hand, the stable formed helium-3 isotope can be filled into nanobubbles facilitating their generation.

The negative potential of the nanobubbles is compensated by either positively charged protium or tritium atoms loosely connected to surrounding water molecules by coulomb forces. It is assumed that by this process, the modified electronic phase space in the nuclear region alters transition moments and the decay process of the nucleus. For example, beta decaying bare nuclei are known to undergo a bound state beta decay as it was observed for the fully-ionised dysprosium-163 66⁺ nucleus which decays within ˜50 days while the neutral dysprosium-163 atom is stable (M. Jung et al., Phys. Rev. Lett. 69(1992) 2164). This bound state beta decay differs from the continuum beta decay mode therein that the electron is not emitted to the vacuum but occupies one of the bound orbitals. Some decay energy is saved in the decay, thus modifying the rate as compared to the one in the neutral atom. An analysis of the formation of beta electrons via the tritium decay showed an increased bound state decay probabilities ³₁H⁺ to ³₁He⁺ (Yu. A. Akulov, B. A. Mamyrin, Phys. Lett. B, Vol. 610, 45-49, 2005). This results in a decrease of the tritium concentration in the contaminated solution. By means of an ultrasound generator in a aqueous 63-Ni(NO)₃ solution microbubbles not exceeding 10 μm were produced which allow to occur the deformed space-time reactions. The analysis of the recorded bremsstrahlung of beta electrons emitted by nickel-63 before and after two runs of sonication for 100 seconds yielded an average radioactivity decrease of 14%. Since nickel-63 has a half-life of 101.2±1.5 years it means that, for obtaining the radioactivity decrease recorded by those experiments, about 22 years would be needed. The authors state that this phenomenon is especially susceptible to experimental conditions to reach and handle the needed energy density in the context of bubble generation.

Alberto Rosada et al. (Alberto Rosado, Fabio Cardone, Pasquale Avino, SN Applied Sciences (2019) 1:1319) reported a transformation of the radionuclide nickel-63 evidenced by a clear radioactivity. They attributed this phenomenon to the occurrence of a nuclear transformation reaction under the deformed space-time conditions: the transformation of a radioactive nucleus into a stable non-radioactive nucleus without radioactivity emission.

Hitherto, nanobubbles were frequently generated in solutions by creating cavities. Cavitation is caused by pressure reduction below the certain critical value. Based on the pressure reduction mechanism, cavitation mechanisms can be classified into four different types (Jay N. Meegoda, Shaini Aluthgun Hewage, and Janitha H. Batagoda, Stability of Nanobubbles, Env. Eng. Sci. Vol. 35, 11, 2018):
Hydrodynamic variation in the pressure of liquid flux due to system geometry
Acoustic: acoustic cavitation produced by applying ultrasound to liquids
Particle: passing high intensity light photons in liquids
Optical: short-pulsed lasers focused into low absorption coefficient solutions

Nanobubbles are further hydrodynamically generated using the following methods:
Dissolving gases in liquids by compressing gas flows in liquids, then releasing those mixtures through nanosized nozzles to create nanobubbles.
Injecting low pressure gases into liquids to break gas into bubbles by focusing, fluid oscillation, or mechanical vibration.

Microbubbles generators have been described by Ushikubo et al (2010: Physicochem. Eng. Aspects) and Takehiko Sato et al (2015: J. Phys.: Conf. Ser.656 012036).

(H₃O₂⁻)ₙ is an aggregation of the water adduct H₃O₂⁻. The H₃O₂⁻ ion is solvated with further water molecules and can be generated by hydrolysis.

JP 2013 140096 A discloses a washing method using nanobubbles in an aqueous solution like water to decontaminate a radioactive substance material. The nanobubbles are generated with a commercially available nanobubble water production apparatus while applying high voltage as well as high pressure. A charging of the nanobubbles with α-particles is not disclosed.

JP 2008 183502 A discloses a method for water treatment with nanobubbles and an apparatus therefore. Therein, nanobubbles are hydrodynamically generated by subjecting an aqueous solution like water to a high pressure. Then, the aqueous solution is irradiated with β-rays which can be stably emitted by thorium-234 as part of the uranium-radium decay series. Thus, hydroxyl groups and/or OH radicals are generated and positioned in the nanobubbles.

An irradiation of the nanobubbles with α-particles at close range is not disclosed which would require a different decay series. Structural modifications would be necessary in order to overcome the low proximity effect of the α-particles. Further, the generation of (H₃O₂⁻)ₙ is not disclosed.

### DESCRIPTION OF THE INVENTION

The problem underlying the present invention was therefore to provide a novel process of decontaminating radioactively contaminated material. The material can either be a liquid material, like tritium containing water or a solid material. The decontaminated material could then be used by humans without the fear of being radioactively contaminated by it. It was a further specific object of the present invention to decontaminate organic materials from nature like soils, wood, cut grass, hay etc. for smoothing the effect of nuclear contamination by nuclear power plant accidents on nature.

This problem has been solved by a process for the decontamination of radioactively contaminated material comprising the steps of
a) Providing radioactively contaminated material in a decontamination bath;
b) Providing a reactor unit comprising a first reactor chamber connected to a second reactor chamber;
c) Electrolyzing water with a ph>7 in the first reactor chamber and generating (H₃O₂⁻)ₙ;
d) Generating nanobubbles in the electrolyzed water of the second reactor chamber;
e) Optionally repeating steps c) and d);
f) Applying pressure to the water which contains nanobubbles;
g) Transferring the pressurized water which contains nanobubbles to a decontamination bath containing an α-ray generator and the radioactively contaminated material;
h) Charging the nanobubbles with α-particles emitted by the α-ray generator; and
i) Bringing the charged nanobubbles in contact with the radioactively contaminated material in the decontamination bath.

The problem can also be solved by an alternative process, characterized in that the steps b-d and f-h are replaced as follows
b) Providing a reactor unit comprising a filter chamber connected to a first reactor chamber;
c) Ionising, standardising and hydrogenising water in the filter chamber;
d) Electrolyzing water with a ph>7 in the first reactor chamber and generating (H₃O₂⁻)ₙ;
f) Applying pressure to the water which contains (H₃O₂⁻)ₙ;
g) Transferring the pressurized water which contains (H₃O₂⁻)ₙ to a decontamination bath containing an α-ray generator and the radioactively contaminated material;
h) Generating nanobubbles in the decontamination bath and charging the nanobubbles with α-particles emitted by the α-ray generator;

Preferably, the water in the first reactor chamber has a pH>7, more preferably below a pH of 10. It was found that stable nanobubbles were generated under pH values above 7, preferably with a pH of 7.5-8.5. Increasing the pH increases the zeta potential of the nanobubbles. Moreover, this will increase hydrogen bonds around the nanobubbles and increases their stability as well. Nanobubbles tend to be smaller in size with increased pH values compared to neutral pH conditions. The nanobubbles have a particle size of 5-50 nm and a proportion of 3-15 vol % regarding the amount of water.

Even though nanobubbles in high pH solutions showed highly negative zeta potential value at the time of generation, it rapidly reduced to values close to zeta potential values of nanobubbles produced with neutral solution pH. Also, the results revealed, nanobubbles in acidic solutions were difficult to generate and those zeta potential values tend to be positive. This confirms the finding that the surface charge of nanobubbles is strongly related to the OH⁻ ion concentration.

The water molecules and the OH⁻ anions form aggregates (step c)) which can be represented by the general formula (H₃O₂⁻)ₙ, with n being an integer substantially larger than 2 and possibly up to 1,000.

By charging the nanobubbles with α-particles emitted by the α-ray generator (step h)), the decontamination bath is refreshed. Further, the occurrence of α-particles as well as α-particle containing He₂²⁺ promotes the formation of reactive nanobubbles, which increases the decontamination efficiency of the process.

By alternatively ionising, standardising and hydrogenising water in the filter chamber (step c)) and afterwards electrolyzing water with a ph>7 in the first reactor chamber and generating (H₃O₂⁻)ₙ (step d)), large amounts of energy can be saved and thus, costs can be reduced. At the same time (H₃O₂⁻)ₙ is provided that is as effective for decontamination as (H₃O₂⁻)ₙ produced in the first and the second reactor chamber.

In the alternative process, the nanobubbles are generated in the decontamination bath for the first time. Thus, transferring them from the first and the second reactor chamber, which are positioned outside of the decontamination bath into it can be omitted. Thereby, process expenses can be reduced leading to a higher economic efficiency.

The radioactively contaminated material can be water, preferably tritiated water or solutions of solid contaminated material solvated in water. By this, for the first time it is possible to remove tritium from the water, e.g. from the water the Fukushima plant generates every day. Thus, potentially a major environmental damage can be avoided.

The radioactively contaminated material can be a solid material. This solid material can be an organic material, e.g. wood, bark, hay, organic components of soil and any product comprising organic components like cotton, wool etc. The solid material can also be an inorganic material, e.g. milled concrete, steel, plastic or any other inorganic component. The solid material can be contaminated by caesium-137.

The α-ray generator can contain thorium. α-particles radiated by thorium are positively charged helium nuclei. In water, these nuclei have a typical diffusion wavelength of about 40 μm until they are thermalized. Due to the increase of the water flow rate by applying pressure, the α-particles can overcome far larger distances before thermalisation. To ensure the overcome of far larger distances, the pressure applied in step f) can be in the range from 1-20 hPa. On their way through the liquid, they are able to capture electrons under formation of helium atoms. Since helium is a noble gas, it is not likely to undergo chemical reactions and is a very stable monoatomic compound.

The thermalized He²⁺ nucleus has a strong tendency to reach the uncharged stable He-state by the uptake of two electrons from the surroundings. In their thermalized state, they can get trapped either as neutral atoms or positively charged particles under forming nanobubbles with surrounding water molecules. Thus, a very effective decontamination can be achieved.

The radioactively contaminated material can be treated in the decontamination bath for a period of 0.25-1 h. A longer treatment is neither effective nor necessary since on the one hand the decontamination efficiency decreases rapidly as time goes by and on the other hand the desired decontamination degree can be achieved by changing several other process parameters.

In the steps c) to e), the temperature of the water can be increased from room temperature to 80° C. or to 90° C. depending on its properties. The temperature can be increased linearly, gradually or even exponentially, whereby the exponential increase is superior against the gradual one. This can be done during a period of 30 min or more, depending on the properties of the water which contains nanobubbles. The increase can be controlled by the pressure exerted by a pump and adjusted by a pressure valve.

During the entire treatment of the radioactively contaminated material, additionally nanobubbles can be generated in the decontamination bath. This results in the advantage that the decontamination bath can be refreshed with nanobubbles during the entire process of the decontamination of radioactively contaminated material. Thus, the process efficiency is enhanced.

The present invention relates further to radioactively decontaminated material obtainable by a process as described above.

The radioactively decontaminated material has preferably a radioactivity below 200 Becquerel/kg. More preferably, the radioactivity is below 100 Becquerel/kg or even below 50 Becquerel/kg. This radioactivity is considerably lower than the limits allowed for human use so the radioactively decontaminated material can be further processed or reused and brought in contact with humans.

The invention relates further to a device for performing a process for the decontamination of radioactively contaminated materials as described above.

The device comprises
i. a decontamination tank;
ii. a reactor unit;
iii. a neutralization installation; and
iv. a pipe.

The device can further comprise an immersion basket which is positioned in the decontamination tank. Solid contaminated material can be placed in the immersion basket. Thus, it can be removed easily after the decontamination process.

The neutralization installation is preferably positioned in water. This results in the advantage that the decontamination bath can be refreshed with α-particles and nanobubbles permanently during the entire process of the decontamination of radioactively contaminated material. Thus, the process efficiency is enhanced.

The neutralization installation preferably comprises
i. a liquid chamber;
ii. a gas chamber;
iii. a spiral chamber; and
iv. a nozzle.

The liquid chamber preferably comprises a mesh and a grid. Both can be made of metallic material like stainless steel or any other material suitable for using in water. Thus, a long lifetime can be achieved.

Preferably, the mesh and the grid are coated with an α-ray generating oxide. Thus, the water guided through the liquid chamber can be refreshed with α-particles during the entire decontamination process. Thereby, the process efficiency can be enhanced.

Preferably, the gas chamber comprises a grid and a ceramic ball. More preferably a plurality of ceramic balls is comprised.

Preferably, the spiral chamber comprises a spiral, a ceramic ball and an outlet port. More preferably, a plurality of ceramic balls and outlet ports is comprised.

Through the outlet ports, refreshed water can be transferred permanently into the decontamination tank. Thus, a high process efficiency can be achieved.

The ceramic balls in the gas chamber and in the spiral chamber are preferably coated with an α-ray generating oxide. Thus, the gas guided through the liquid chamber and the water guided through the spiral chamber can be refreshed with α-particles during the entire decontamination process. Thereby, the process efficiency can be enhanced.

Preferably, the nozzle comprises a gas pipe. Thus, a precise injection of the gas into the water can be achieved whereby the formation of nanobubbles is supported. Thereby, the process efficiency can be enhanced.

The reactor unit can further comprise
i. a first reactor chamber comprising an electrode; and
ii. a second reactor chamber comprising a spiral.

These components can be part of the reactor unit. Thereby, the structure of the first chamber enables the electrolysis of water with a ph>7 and the generation of (H₃O₂⁻)ₙ. Further, the generation of nanobubbles in the second reactor chamber is enabled. Thus, the inventive process can be carried out effectively.

Alternatively, the reactor unit can further comprise
i. a filter chamber; and
ii. a first reactor chamber comprising an electrode.

These components can be part of the reactor unit. Thereby, the water can be ionised, standardised and hydrogenated with the filter chamber. Further, the structure of the first chamber enables the electrolysis of water with a ph>7 and the generation of (H₃O₂⁻)ₙ. Thus, the alternative inventive process can be carried out effectively.

The electrode can comprise a plurality of electrode rods and a plurality of sheets. The sheets can be used to segment the electrode into single electrolytic cells. By passing the electrolyzed water through a plurality, preferably six or seven electrolytic cells, a high efficiency of nanobubble creation can be achieved.

For example, with seven electrolytic cells, ca. 40% more nanobubbles can be created than with using three, four and five or eight, nine and ten electrolytic cells.

The sheets of the device can comprise openings. This enables an effective flow behaviour of the gaseous part of the fluid in the first reactor chamber, which otherwise tends to dam up in the liquid part of the fluid.

The electrode can be a three-phase electrode longitudinally arranged in segments. In difference to a two-phase electrolysis done with a two phase electrode with direct current, where H₂O is simply broken up in two H and one O evaporating, the three-phase current applied through the three-phase electrode in the first reactor chamber causes water and oxygen dissolved in water to be transformed into (H₃O₂⁻)ₙ. Such process is reinforced by the segmented structure working effectively as a system of a plurality of three-phase electrodes formed with the segments. The segments can be connected through lateral openings. Thus, the process is reiterated multiple times.

The electrode of the device can be arranged in a housing with openings. The housing enables a controlled contacting of the electrode and the water to be electrolysed. Thus, the process efficiency is enhanced. The openings of the housing enable a continuous processing. Thus, the water throughput can be enhanced.

The electrode can comprise at least 12 electrode rods. Thus, a high efficiency of nanobubble creation can be achieved. Due to limitations in assembly space and costs, the number of electrode rods should not exceed 21.

The alternative reactor unit preferably comprises a plurality of filter chambers which are
i. an ion exchange filter; and/or
ii. a stone filter; and/or
iii. an obsidian stone filter.

Thus, an effective generation of (H₃O₂⁻)ₙ with minimum energy consumption is enabled.

### BRIEF DESCRIPTION OF THE FIGURES

FIG. 1a shows a schematic view of a system of reactor units for the use of generating nanobubbles in (H₃O₂⁻)ₙ.

FIG. 1b shows a schematic view of a system of filter chambers and a first reactor chamber generating (H₃O₂⁻)ₙ.

FIG. 2a shows a schematic view of a decontamination bath for solid material.

FIG. 2b shows a schematic view of a decontamination bath for water.

FIG. 3a shows a schematic view of a neutralization installation.

FIG. 3b shows a schematic view of a liquid chamber as a part of a neutralization installation.

FIG. 3c shows a schematic view of a gas chamber as a part of a neutralization installation.

FIG. 3d shows a schematic view of a spiral chamber as a part of a neutralization installation.

FIG. 4a shows a schematic view of a cylindrical electrode with 12 electrode rods.

FIG. 4b shows a schematic view of a cylindrical electrode with seven electrode rods in a housing with openings.

### DESCRIPTION OF THE PREFERRED EMBODIMENTS

The present invention is explained in more detail with the following description without being meant as unduly limiting its scope to specific embodiments.

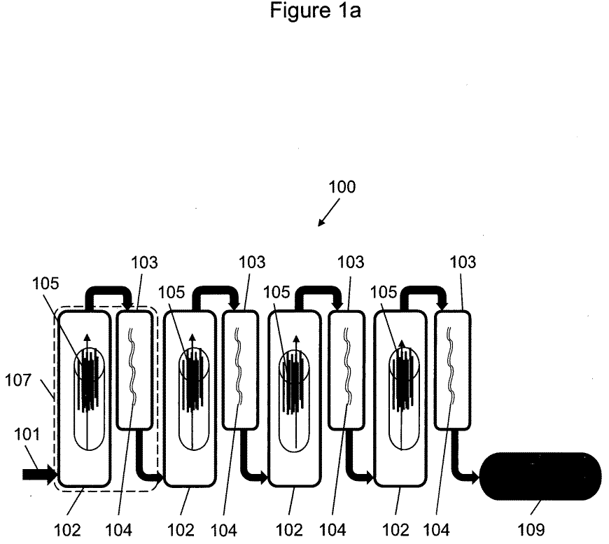

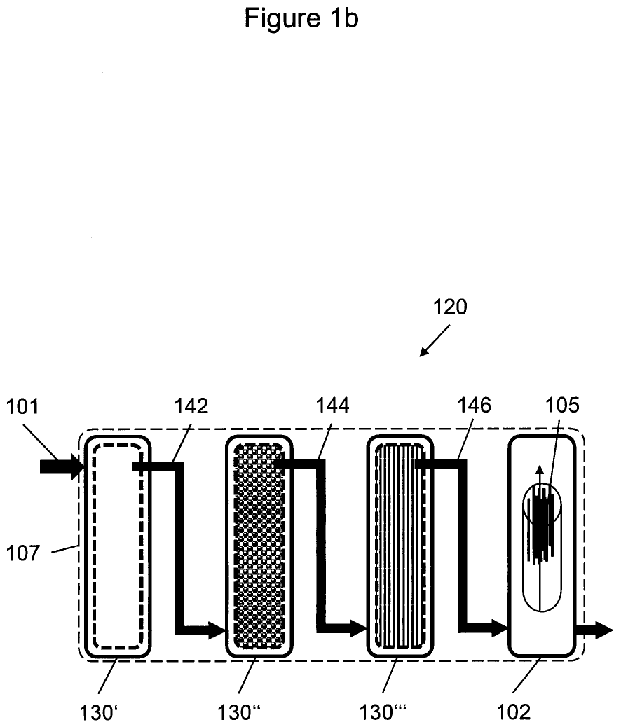

The inventive process is described based on the system of reactor units generating nanobubbles in (H₃O₂⁻)ₙ 100 displayed in FIG. 1a. Water, e.g. filtered tap water is pumped into the system of reactor units generating nanobubbles in (H₃O₂⁻)ₙ 100 with an input pump 101. The exerting pressure in the system of reactor units generating nanobubbles in (H₃O₂⁻)ₙ 100 is controlled by a pressure valve 109.

The system of reactor units generating nanobubbles in (H₃O₂⁻)ₙ 100 comprises reactor units 107 of a first reactor chamber 102 and a second reactor chamber 103 each. In FIG. 1a, four reactor units 107 are displayed, whereas in a preferred embodiment, six or seven reactor units 107 are used. Thus, ca. 40% more nanobubbles can be created as with less or more reactor units 107.

The first reactor chamber 102 is used to exchange oxygen with the water and create bubbles in it, thus transforming the water into (H₃O₂⁻)ₙ. Then, in the second reactor chamber 103 nanobubbles are created.

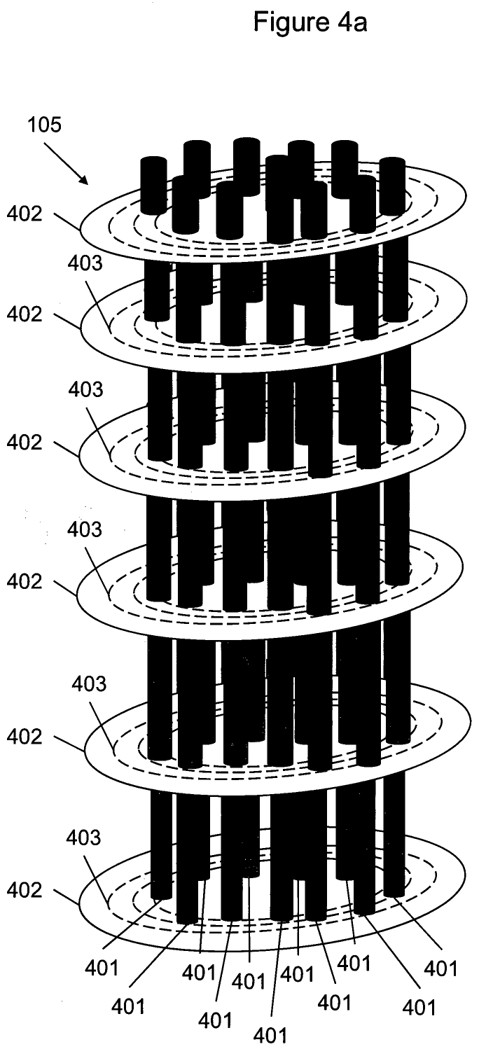

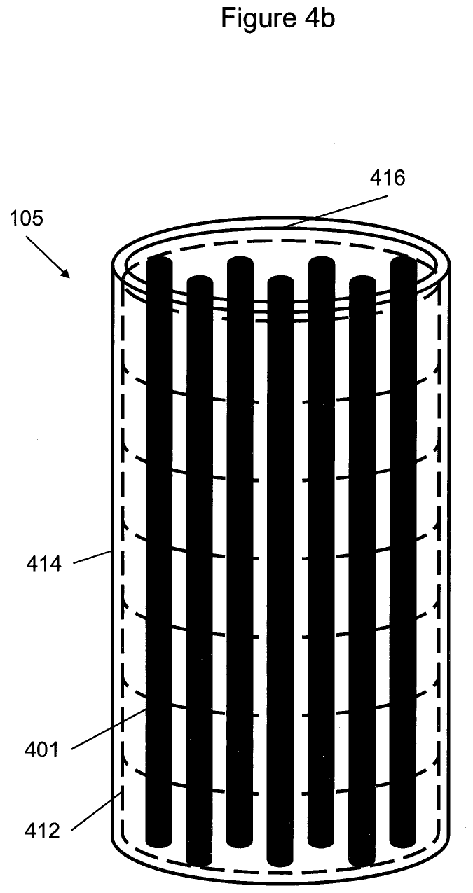

The first reactor chamber 102 typically consists of a stainless-steel cylinder with a length of 260 mm and a diameter of 55 mm, i.e. with a volume of ca. 617.76 cm³. In another embodiment, it has a much bigger volume, e.g. 30 m³. It contains an electrode 105, which is displayed e.g. in FIG. 4a and described in a subsequent section.

In a preferred embodiment, the electrode 105 in the first reactor chamber 102 is a three-phase electrode. Thereby, a three-phase current can be applied, e.g. with an average voltage of 200 V and an electric current of 220 A. The parameters of the three-phase current depend on the water quality used and can be adjusted by a person skilled in the art by means of some simple preliminary tests. The first nanobubbles are observed after passing the first reactor chamber 102. The flow of the water is indicated by arrows.

The second reactor chamber 103 consists of a stainless-steel cylinder with a length of 120 mm and a diameter of 19 mm, i.e. with a volume of ca. 339.6 cm³. It contains a spiral 104 which is in a preferred embodiment crafted from a rectangular metal sheet with a size of 120·18 mm². The metal can be stainless steel or aluminium.

In the second reactor chambers 103, nanobubbles are created. By repeating the electrolysis in the first reactor chambers 102 and the creation of nanobubbles in the second reactor chambers 103, at the end of the process, i.e after the water has passed through all reactor units 107, a stream of highly concentrated nanobubbles of (H₃O₂⁻)ₙ referred to as nano-(H₃O₂⁻)ₙ 210 in water having aggregates is created.

In a preferred embodiment, the nanobubbles are exposed to α-radiation. Thereby, the α-particles themselves can be stabilised by strong dipolar water molecules promoting nanobubble formation. Positively charged helium atoms are likely to form stable He₂²⁺ molecules with a bonding order of one by combination with a helium atom. This can be shown by standard quantum mechanical calculations using the method of linear combination of atomic orbitals. Driven by the two positive charges, the molecules have the strong tendency to attract two further electrons from the environment.

Upon this event, dissociation into two separate helium atoms may occur which either stabilize the created nanobubbles or will contribute to the formation of further nanobubbles upon diffusion. However, the He₂²⁺ molecules are able to transform again to helium upon interaction of the α-particle. Further, the noble gas radon which is formed during the thorium decay cascade can be emitted in the surrounding water and act as an α-ray generator in nanobubbles.

An alternative device for the generation of (H₃O₂⁻)ₙ is displayed in FIG. 1b with a system of filter chambers and a first reactor chamber generating (H₃O₂⁻)ₙ. The generation of (H₃O₂⁻)ₙ begins with pumping water into a reactor unit 107 by an input pump 101. First, it is transferred to an ion exchange filter 130′ which ionises the water. Thus, ionised water 142 is produced which is transferred to a stone filter 130″ where water clusters are broken down. Thereby, ionised and standardised water 144 is produced which is transferred to an obsidian stone filter 130′″ where its active hydrogen contents are increased. Thus, ionised, standardised and hydrogenated water 146 is produced which is transferred to a first reactor chamber 102. There, it is electrolyzed by an electrode 105.

The ion exchange filter 130′ can contain an ion exchange resin or an ion exchange polymer that acts as a medium for ion exchange. The exchanged ions can be cations or anions.

The stone filter 130″ can be made of barley stone, granite or any other fine-pored mineral stone.

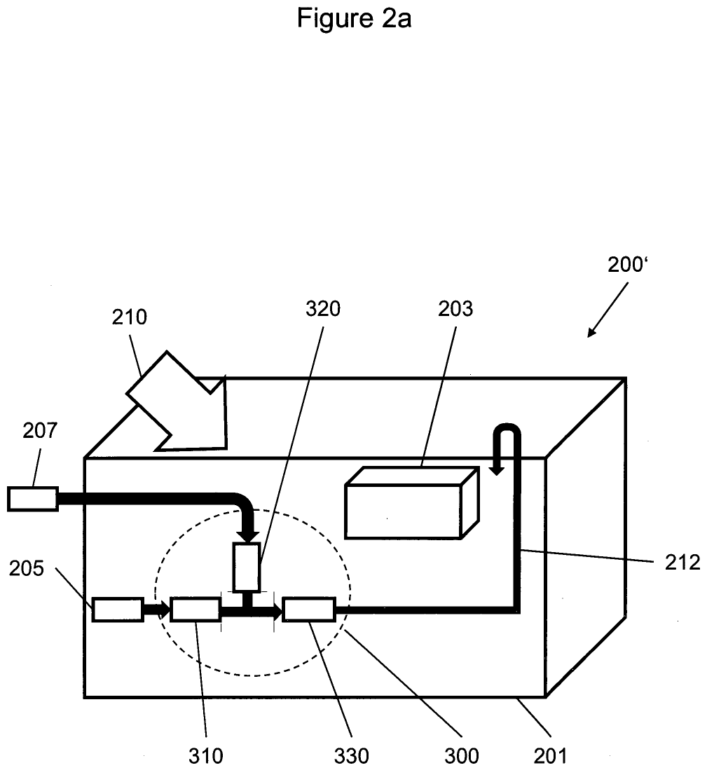

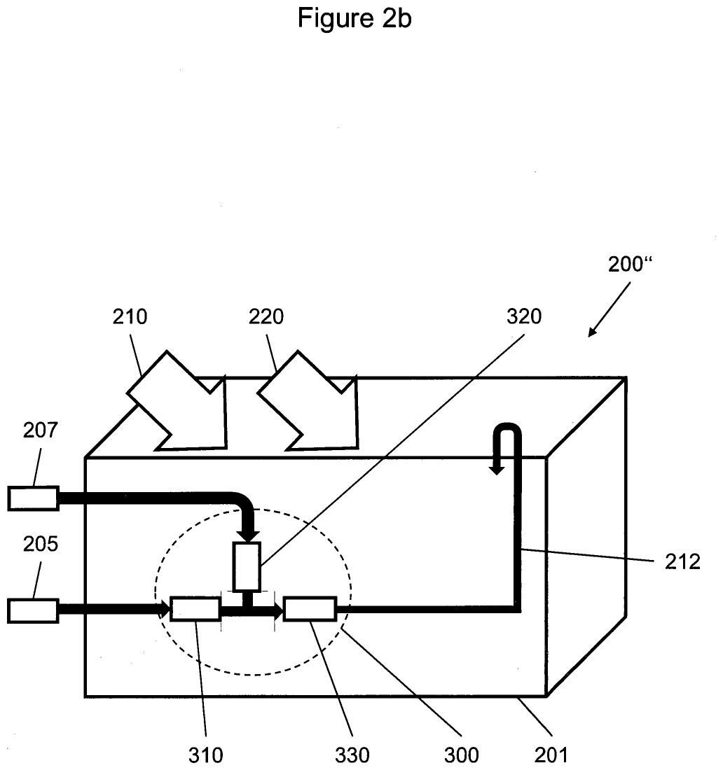

The decontamination of solid material and water is conducted using specific embodiments of a decontamination bath 200. For solid material, it is a decontamination bath for solid material 200′ as displayed in FIG. 2a. For water, it is a decontamination bath for water 200″ as displayed in FIG. 2b.

In both embodiments, the decontamination bath 200 comprises a decontamination tank 201 which in a preferred embodiment consists of a stainless-steel container with an open top. In a preferred embodiment it is of rectangular shape with a size of e.g. 150·200·100 mm³ and a volume of 30 l.

For the decontamination, nano-(H₃O₂⁻)ₙ 210 are filled into the decontamination tank 201, where they are charged with α-particles. In a preferred embodiment, the nanobubbles are refreshed with additional stirring devices.

For the decontamination of solid material, the contaminated solid material is immersed in the decontamination bath for solid material 200′ in an immersion basket 203. In a preferred embodiment, the solid material to be decontaminated is left in the decontamination tank 201 for at least 15 minutes and maximum 30 minutes. A circulation pump 205 which is positioned in the decontamination tank 201 pumps the process fluid into a liquid chamber 310. In a preferred embodiment, the circulation pump 205 is a standard cascade pump with a leverage of 20 m.

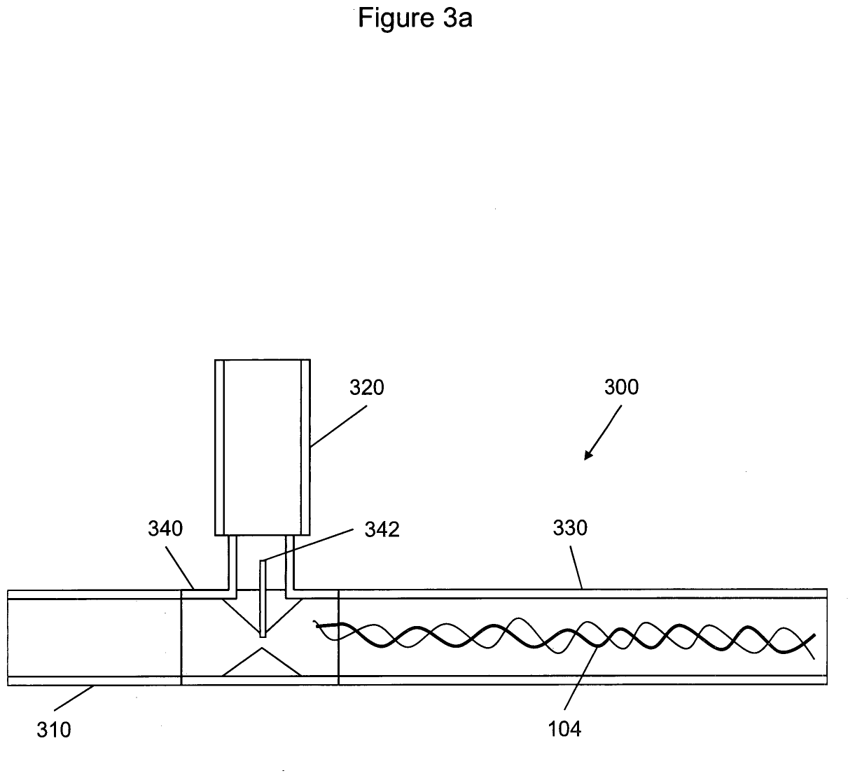

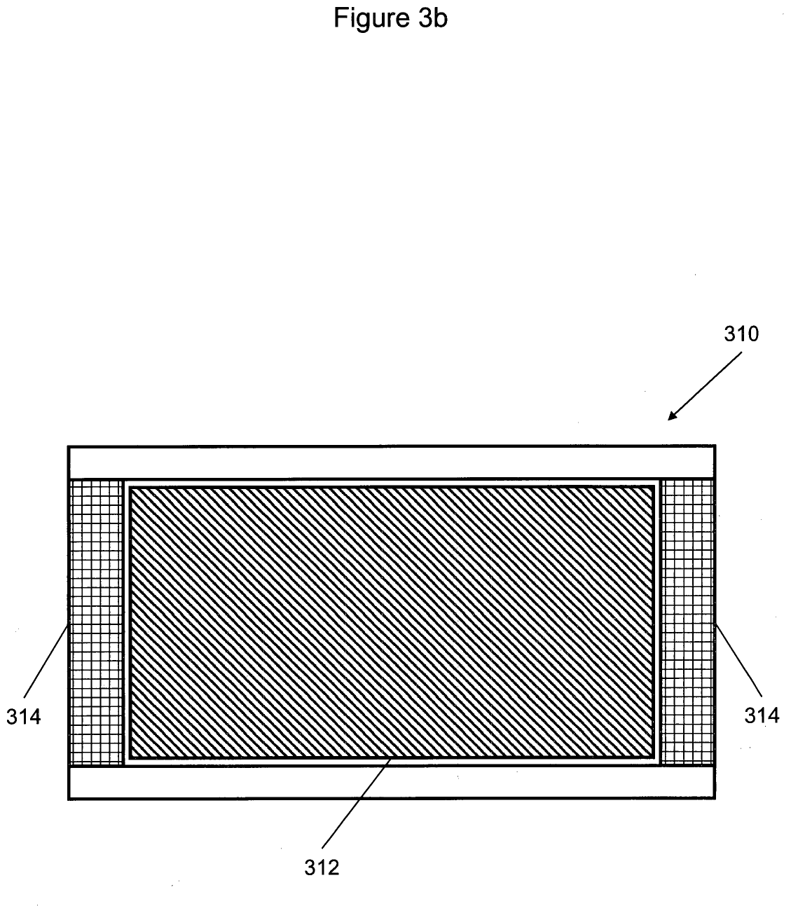

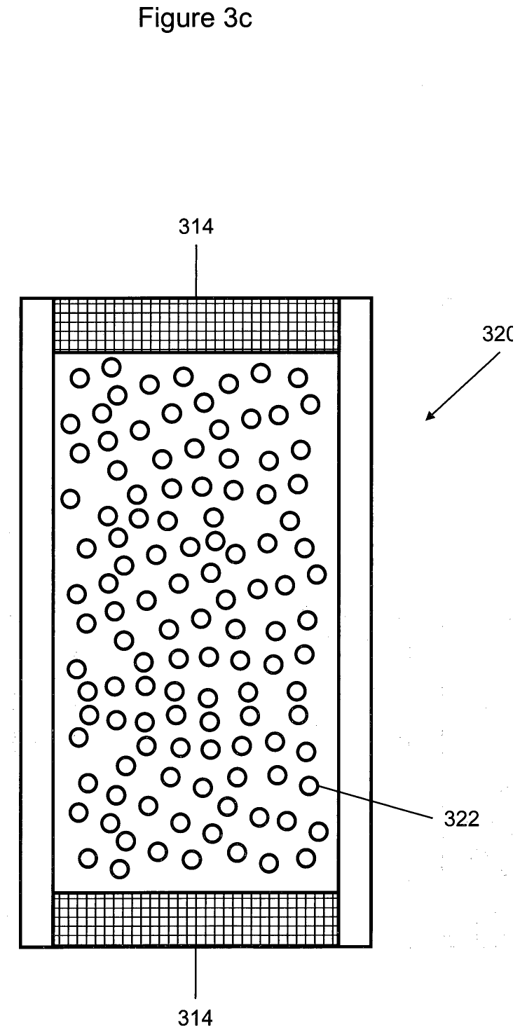

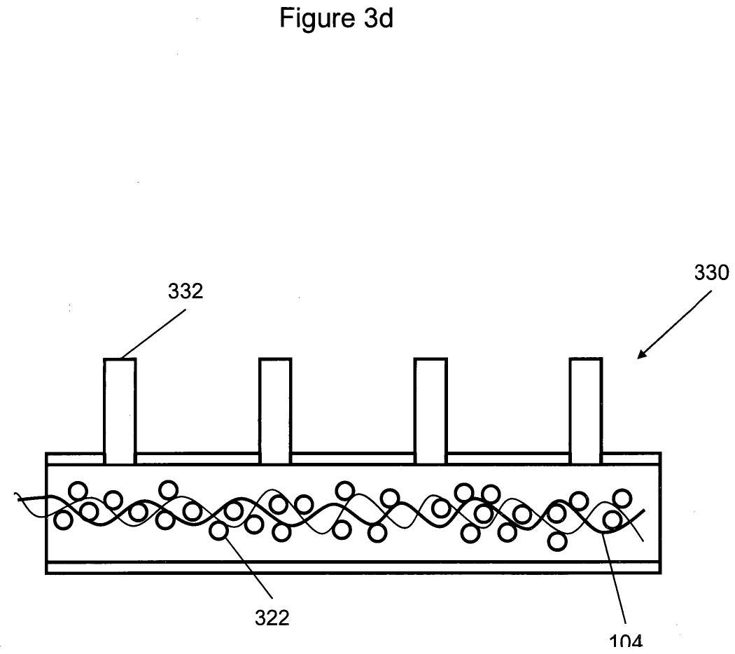

The liquid chamber 310 is preferably an aluminum-brass amalgamated cylinder with a length of 200 mm and a diameter of 25 mm. In a preferred embodiment, it is filled with a mesh 312 as displayed in FIG. 3b which can be a roll of an aluminum mesh coated with thorium. In another preferred embodiment, the liquid chamber 310 contains ceramic balls 322. Preferably, the ceramic balls 322 have a diameter of 5 mm and are coated with thorium with a coating thickness in the range of 0.1-0.5 mm. The thorium coating is fixed on the ceramic balls 322, by a thermal process which takes 20-30 minutes.

The ceramic balls 322 are preferably spherical. Despite that, their geometry is not bound to be spherical. Alternatively, ceramic balls 322 of any other geometry suitable to be coated with thorium can be used, e.g. cubes, tubes, granules or flakes. In a preferred embodiment, the liquid chamber 310 is filled with about 750 ceramic balls 322 which are held in the chamber by grids 314 sealing the entry and the exit side. In a preferred embodiment, these grids 314 are coated with an α-particle emitting material, e.g. thorium. In another preferred embodiment, the liquid chamber is filled with thorium oxide granules.

The radioactivity of the α-rays is in the range of 1-100 MBq/kg, preferably 10-80 MBq/kg. A preferred example of the radioactivity is 17 MBq/kg. The energy of the emitted α-radiation is preferably in the range of 4-10 MeV. The exposure time of the nano-(H₃O₂⁻)ₙ 210 to the α-radiation is in the range of 15 minutes to 1 hour, preferably 15-45 min.

Simultaneously, a compressor 207 presses gas, e.g. air, helium, hydrogen or CO₂ through a gas chamber 320. The gas type varies depending on the liquid radioactively contaminated material 220 and other features of the respective decontamination process. In a preferred embodiment, this gas chamber 320 is filled with ceramic balls 322 as displayed in FIG. 3c.

Thereupon, both streams from the liquid chamber 310 and the gas chamber 320 are mixed in a nozzle 340 and from there pressed into a spiral chamber 330 by the circulation pump 205. In a preferred embodiment, the nozzle 340 exhibits a gas pipe 342 adjacent to the gas chamber 320 enabling a targeted transfer of the gas from the gas chamber 320 to the nozzle 340.

In a preferred embodiment, it comprises three end-openings as displayed in FIG. 3a. The openings cross sections correspond to the adjacent chambers and are in a preferred embodiment of circular shape to enable a smooth flow. In a preferred embodiment, the opening towards the liquid chamber 310 has a diameter of 25 mm, of 15 mm towards the gas chamber and of 10 mm towards the spiral chamber. The reduction of the size of the flow cross sectional areas along the flow direction leads to an increase of the pressure in the neutralization installation 300, thus enabling a high process efficiency.

In a preferred embodiment, the spiral chamber 330 is a stainless-steel cylinder with a length of 150 mm and a diameter of 15 mm containing another aluminium spiral 104 with a length of 150 mm and a diameter of 13 mm. In a preferred embodiment, outlet ports 332 are positioned at the outer wall of the spiral chamber 330. Thus, nanobubbles can get emitted to the decontamination tank 201 continuously. Preferably, additional ceramic balls 322 are positioned in the spiral chamber 330 adjacent to the spiral 104. The spiral 104 refreshes the nanobubbles and the ceramic balls 322 refresh the load with α-particles and stabilize the decontamination degree of the output of the spiral chamber 330. In a preferred embodiment, multiple spiral chambers 330 are connected in a row one behind the other, e.g. up to 18 times. Thus, the decontamination degree is enhanced.

In a preferred embodiment, the liquid chamber 310, the gas chamber 320, the spiral chamber 330 and the nozzle 340 form a neutralization installation 300 as displayed in FIG. 3a. The water processed in the neutralization installation 300 is withdrawn via a pipe 212. It can be led directly into the decontamination tank 201 or led into another decontamination tank 201 of another decontamination bath 200. Thereby, it is possible to combine e.g. a decontamination bath for solid material 200′ with a decontamination bath for water 200″ with a single neutralization installation, a single compressor 207 and a single circulation pump 205. Thus, the installation costs can be reduced as well as the construction space.

Opposing to the decontamination bath for solid material 200′, the circulation pump 205 in the decontamination bath for water 200″ is positioned outside the decontamination tank 201. Depending on the requirements of water throughput of the liquid chamber 310 installed in the decontamination bath for water 200″, it can be of smaller size compared to that of the decontamination bath for solid materials 200′. Accordingly, the gas chamber 320 can comprise less ceramic balls 322 and the nozzle 340 can be of smaller size.

The liquid radioactively contaminated material 220, e.g. tritiated water or solutions of solid contaminated ground material solvated in water is filled into the decontamination tank 201 together with the nano-(H₃O₂⁻)ₙ 210. The ratio of the two liquids depends on the contamination degree of the liquid radioactively contaminated material 220. A higher decontamination degree requires more nano-(H₃O₂⁻)ₙ 210 and vice versa.

The circulation of the mixed liquids through the neutralization installation 300 is repeated until the radioactivity in the decontamination tank 201 reaches radiologically uncritical levels, e.g. a radioactivity below 200 Becquerel/kg.

In FIG. 4a a preferred embodiment of the electrode 105 is displayed. It is a three-phase electrode with a total length of 215 mm composed of a plurality of electrode rods 401. To enable a three-phase current, the number of electrode rods 401 has to be a multiple of 3, e.g. 12, 15, 18 or 21. Preferably, the electrode rods 401 have a diameter of 5 mm and consist of titanium or iron. If the resulting nano-(H₃O₂⁻)ₙ 210 is not intended for human consumption, the electrode rods 401 can also consist of stainless steel, which is not allowed to use for the production of drinking liquids as it emits harmful chrome. In a preferred embodiment, the electrode rods 401 comprise a platin amalgamated surface to prevent corrosion.

Preferably, the electrode rods 401 pierce through vertically positioned sheets 402, e.g. made from a plastic like PTFE. In a preferred embodiment, the electrode 105 comprises six sheets 402, resulting in a segmenting of the electrode 105 into seven segments 412. The segmentation is displayed in FIG. 4b. Preferably, the sheets 402 sealing tight with the wall of the housing 414, except for lateral openings 403 in each sheet 402 at one side opposite to the adjacent segment 412. Preferably, the housing 414 of the electrode 105 comprises openings 416 at the entry and the exit side to enable a continuous flow and thus, a continuous process. Preferably, the water is rising gradually up through the electrode 105. The lateral openings 403 in the sheets 402 induce a spiral flow of the water which flow direction is indicated in FIG. 1a with arrows in the first reactor chamber 102.

Preferably, the maximum power applied to the electrode rods 401 is 145,000±2,000 W. This value depends on the water quality used and can be adjusted in the above ranges by a person skilled in the art by means of some simple preliminary tests.

The experiment described in the following was carried out conducting the process and using the device of the present invention as described above. Radioactively contaminated bark from a poplar tree collected at 35 km distance to the Fukushima reactor (samples A, B and C) was washed in a decontamination tank 201 with nano-(H₃O₂⁻)ₙ 210 and with normal tap water (control sample A). The amount of iod-131 and the caesium isotopes caesium-134 and caesium-137 was measured before and after applying the decontamination process (before washing/after washing). The measurement method for nuclide measurement was carried out with gamma ray spectrometry using a germanium semiconductor detector. The results are displayed in the following table.

TABLE 1
Radioactivity of iod-131 and of the caesium isotopes caesium-
134 and caesium-137 in the bark samples A, B and C after treatment with
nano-(H₃O₂⁻)ₙ and with tap water

| | | Radioactivity [Becquerel/kg] | | | |
|---|---|---|---|---|---|
| Sample | | I-131 | Cs-134 | Cs-137 | Cs |
| A | before washing | no result | 188 | 1,110 | 1,298 |
| | after washing | no result | 13.1 | 76.5 | 89.4 |
| B | before washing | no result | 241 | 1,380 | 1,621 |
| | after washing | no result | 16.4 | 105 | 121.4 |
| C | before washing | no result | 145 | 1,017 | 1,162 |
| | after washing | no result | 11.9 | 82.7 | 94.6 |
| control | before washing | no result | 188 | 1,110 | 1,298 |
| sample A | after washing | no result | 154 | 765 | 819 |
| (tap water) | | | | | |

The bark of the samples A, B and C show that the radioactivity is reduced to less than 200 Becquerel/kg or even less. Thus, it can be reused as a raw material for compost and soil conditioner.

### REFERENCE LIST

100 System of reactor units generating nanobubbles in (H₃O₂⁻)ₙ

101 Input pump

102 First reactor chamber

103 Second reactor chamber

104 Spiral

105 Electrode

107 Reactor unit

109 Pressure valve

120 System of filter chambers and a first reactor chamber generating (H₃O₂⁻)ₙ

130 Filter chamber

130′ Ion exchange filter

130″ Stone filter

130″′ Obsidian stone filter

142 Ionised water

144 Ionised and standardised water

146 Ionised, standardised and hydrogenated water

200 Decontamination bath

200′ Decontamination bath for solid material

200″ Decontamination bath for water

201 Decontamination tank

203 Immersion basket

205 Circulation pump

207 Compressor

210 nano-(H₃O₂⁻)ₙ

212 Pipe

220 Liquid radioactively contaminated material

300 Neutralization installation

310 Liquid chamber

312 Mesh

314 Grid

320 Gas chamber

322 Ceramic ball

330 Spiral chamber

332 Outlet port

340 Nozzle

342 Gas pipe

401 Electrode rod

402 Sheet

403 Opening

412 Segment

414 Housing

416 Opening

1. Process for the decontamination of radioactively contaminated material comprising the steps of
a) Providing radioactively contaminated material in a decontamination bath (200);
b) Providing a reactor unit (107) comprising a first reactor chamber (102) connected to a second reactor chamber (103);
c) Electrolyzing water with a ph>7 in the first reactor chamber (102) and generating (H₃O₂⁻)ₙ ;
d) Generating nanobubbles in the electrolyzed water of the second reactor chamber (103);
e) Optionally repeating steps c) and d);
f) Applying pressure to the water which contains nanobubbles;
g) Transferring the pressurized water which contains nanobubbles to a decontamination bath (200) containing an α-ray generator and the radioactively contaminated material;
h) Charging the nanobubbles with α-particles emitted by the α-ray generator; and
i) Bringing the charged nanobubbles in contact with the radioactively contaminated material in the decontamination bath (200).

2. Process according to claim 1, characterized in that the steps b-d and f-h
are replaced as follows
b) Providing a reactor unit (107) comprising a filter chamber (130) connected to a first reactor chamber (102);
c) Ionising, standardising and hydrogenising water in the filter chamber (130);
d) Electrolyzing water with a ph>7 in the first reactor chamber (102) and generating (H₃O₂⁻)ₙ;
f) Applying pressure to the water which contains (H₃O₂⁻)ₙ;
g) Transferring the pressurized water which contains (H₃O₂⁻)ₙ to a decontamination bath (200) containing an α-ray generator and the radioactively contaminated material;
h) Generating nanobubbles in the decontamination bath (200) and charging the nanobubbles with α-particles emitted by the α-ray generator;

3. Process according to claim 1, wherein the radioactively contaminated material is water.

4. Process according to claim 3, wherein the water contains tritium.

5. Process according to claim 1, wherein the radioactively contaminated material is a solid material.

6. Process according to claim 5, wherein the solid material is an organic material.

7. Process according to claim 5, wherein the solid material is an inorganic material.

8. Process according to claim 5, wherein the solid material contains caesium-137.

9. Process according to claim 1, wherein the pressure applied in step f) is in the range from 1 hPa to 20 hPa.

10. Process according to claim 1, wherein the radioactively contaminated material is treated in the decontamination bath (200) for a period of 0.25 h to 1 h.

11. Process according to claim 1, wherein in the steps c) to e) the temperature of the water is increased from room temperature to 80° C.

12. Process according to claim 1, wherein additionally nanobubbles are generated in the decontamination bath (201) during the entire treatment of the radioactively contaminated material.

13. Radioactively decontaminated material obtainable by a process according to claim 1.

14. Radioactively decontaminated material according to claim 13 having a radioactivity below 200 Becquerel/kg.

15. Device for performing a process for the decontamination of radioactively contaminated materials according to claim 1 comprising
i. a decontamination tank (201);
ii. a reactor unit (107);
iii. a neutralization installation (300); and
iv. a pipe (212).

16. Device according to claim 15, wherein an immersion basket (203) is positioned in the decontamination tank (201).

17. Device according to claim 15, wherein the neutralization installation (300) is positioned in water.

18. Device according to claim 15, wherein the neutralization installation (300) comprises
i. a liquid chamber (310);
ii. a gas chamber (320);
iii. a spiral chamber (330); and
iv. a nozzle (340).

19. Device according to claim 18, wherein the liquid chamber (310) comprises a mesh (312) and a grid (314).

20. Device according to claim 19, wherein the mesh (312) and/or the grid (314) are coated with an α-ray generating oxide.

21. Device according to claim 18, wherein the gas chamber (320) comprises a grid (314) and a ceramic ball (322).

22. Device according to claim 18, wherein the spiral chamber (330) comprises a spiral (104), a ceramic ball (322) and an outlet port (332).

23. Device according to claim 21, wherein the ceramic ball (322) is coated with an α-ray generating oxide.

24. Device according to claim 18, wherein the nozzle (340) comprises a gas pipe (342).

25. Device according to claim 15, wherein the reactor unit (107) comprises
i. a first reactor chamber (102) comprising an electrode (105); and
ii. a second reactor chamber (103) comprising a spiral (104).

26. Device according to claim 15, wherein the reactor unit (107) comprises
i. a filter chamber (130); and
ii. a first reactor chamber (102) comprising an electrode (105).

27. Device according to claim 25, wherein the electrode (105) comprises a plurality of electrode rods (501) and a plurality of sheets (502).

28. Device according to claim 27, wherein the sheets (502) comprise openings (503).

29. Device according to claim 25, wherein the electrode (105) is a three-phase electrode longitudinally arranged in segments (512).

30. Device according to claim 25, wherein the electrode (105) is arranged in a housing (514) with openings (516).

31. Device according to claim 25, wherein the electrode (105) comprises at least 12 electrode rods (501).

32. Device according to claim 26, wherein the reactor unit (107) comprises a plurality of filter chambers (130) which are
i. an ion exchange filter (130′); and/or
ii. a stone filter (130″); and/or
iii. an obsidian stone filter (130″′).
